(19) United States
(12) Patent Application Publication
(10) Pub. No.: US 2026/0310804 A1
(43) Pub. Date: Oct. 8, 2026

(54) DATA TRANSFER BETWEEN TWO DATA PROCESSING UNITS

(71) Applicant: Siemens Aktiengesellschaft, 80333 München (DE)

(72) Inventors: WOLFGANG GEBHARDT, Erlangen (DE); AXEL HAASCH, Erlangen (DE); HUBERT HARDES, Erlangen (DE); JENS NEUNER, Erlangen (DE); ALEXANDER PFISTER, Erlangen (DE)

(73) Assignee: Siemens Aktiengesellschaft, 80333 München (DE)

(21) Appl. No.: 19/480,675

(22) PCT Filed: Apr. 2, 2024
(86) PCT No.: PCT/EP2024/058892

§ 371 Date: Oct. 31, 2025

(30) Foreign Application Priority Data
May 2, 2023 (EP) 23171035.1

(51) Int. Cl. G06F 21/60; H04L 9/08

(52) U.S. Cl. CPC G06F 21/606; H04L 9/0822; H04L 9/0861; G06F 2221/2107

(57) ABSTRACT

In a method for data transfer between two data processing units, a secret key is generated and encrypted using an additional key provided from a first external storage medium. The encrypted secret key is stored on the first external storage medium. Data stored on a first data processing unit are encrypted with the secret key, and the encrypted data are provided to a second data processing unit. The encrypted secret key and the additional key are read from the first external storage medium by the second data processing unit and the encrypted secret key is decrypted by the second data processing unit with the additional key. The data encrypted with the secret key are decrypted with the secret key by the second data processing unit.

Independent of the grammatical term usage, individuals with male, female or other gender identities are included within the term.

The invention relates to a method for data transmission between two data processing units.

In particular, the invention relates to the transmission of sensitive data, for the reading of which a read authorization is required, between two data processing units. Such data is secured by encryption before being transmitted from a first data processing unit to a second data processing unit. Decrypted data processing unit. For this purpose, the key for decrypting the data must be known or made known to the second data processing unit.

The object of the invention is to disclose a method for data transmission between two data processing units, which is improved with regard to the encryption and decryption of data to be transmitted. It must be taken into account that the processed data must be integrity-protected.

The object is achieved in accordance with the invention by a method having the features of claim 1.

Advantageous embodiments of the invention are the subject matter of the subordinate claims.

In the method in accordance with the invention, data is transmitted from a first data processing unit to a second data processing unit, wherein
a secret key is generated,
the secret key is encrypted using an additional key that is provided by a first external storage medium and the encrypted secret key is stored on the first external storage medium,
data that is stored on the first data processing unit is encrypted using the secret key and the data that is encrypted using the secret key is provided to the second data processing unit,
the encrypted secret key and the additional key are read from the first storage medium by the second data processing unit,
the encrypted secret key is decrypted by the second data processing unit by means of the additional key, and
the data that is encrypted using the secret key is decrypted by the second data processing unit by means of the secret key.

The method in accordance with the invention therefore provides for the data that is to be transmitted from the first data processing unit to the second data processing unit to be encrypted using a secret key before the data is transmitted. The encrypted data is provided to the second data processing unit. The second data processing unit therefore requires the secret key in order to decrypt the data.

The invention provides a first storage medium for decrypting the data. The first storage medium provides an additional key for encrypting the secret key. The additional key is used to encrypt the secret key and the encrypted secret key is stored on the first storage medium. The encrypted secret key is therefore stored exclusively and preferably in a copy-protected manner on the first storage medium and is thus bound to the first storage medium.

The encrypted data can thus be decrypted by means of the first storage medium without knowing the secret key.

In one embodiment of the invention, the data that is encrypted using the secret-key is provided to the second data processing unit in that the encrypted data is first copied from the first data processing unit to the first external storage medium or to a second external storage medium and is provided to the second data processing unit by the first external storage medium or the second external storage medium.

In accordance with the aforementioned embodiment of the invention, the encrypted data is therefore stored on the first external storage medium or a second external storage medium. The data is thereby backed up to the first external storage medium or the second external storage medium and can also be provided by the first external storage medium or the second external storage medium to various data processing units.

In a further embodiment of the invention, the additional key is a salt. The salt is, for example, a specific character string that is stored on the first external storage medium, for example a serial number of the first external storage medium. As an alternative, the salt is a random character string that is generated by the first external storage medium. The salt preferably meets internationally recognized or recommended guidelines that set a minimum safety standard.

In this case, the generation of the salt as a random character string by the first external storage medium is preferred to a specific character string that is stored as a salt on the first external storage medium, in particular if the first external storage medium is used for encrypting various secret keys. In this case, a random character string can be generated as a salt for each secret key that is to be encrypted, as a result of which the security of the encryption of the secret key is advantageously increased.

In a further embodiment of the invention, the additional key is stored in a secure storage area of the first external storage medium. A secure storage area is understood here as a so-called secure storage area, which is in particular copy-protected.

In a further embodiment of the invention, the secret key is generated by the first data processing unit and is stored in a secure storage area of the first data processing unit.

The storage of the secret key in a secure storage area of the first data processing unit advantageously increases the security of the encryption of the data.

In a further embodiment of the invention, the secret key is stored in a secure storage area of the second data processing unit.

The storage of the secret key in a secure storage area of the second data processing unit also advantageously increases the security of the encryption of the data.

In a further embodiment of the invention, the first external storage medium is a memory card, in particular a memory card having a secure storage area in which the encrypted secret key is stored. The second external storage medium can also be a memory card. As an alternative, the second external storage medium is any other storage device, for example a hard disk.

The above-described characteristics, features and advantages of this invention and also the manner in which these are achieved become clearer and more easily understandable in conjunction with the following description of exemplary embodiments that are further explained in conjunction with the drawings. It is shown in:

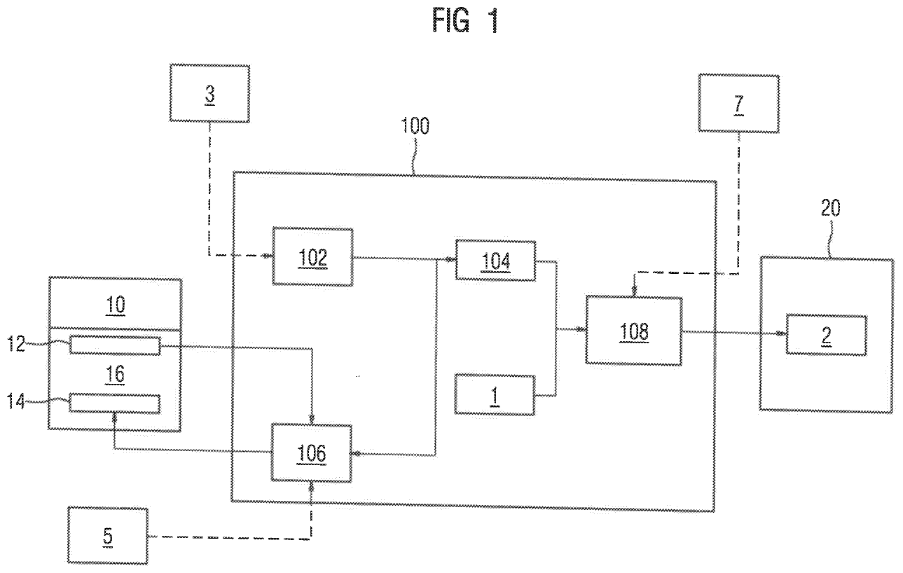

FIG. 1 a block diagram of an encryption of data in accordance with an exemplary embodiment of the method in accordance with the invention,

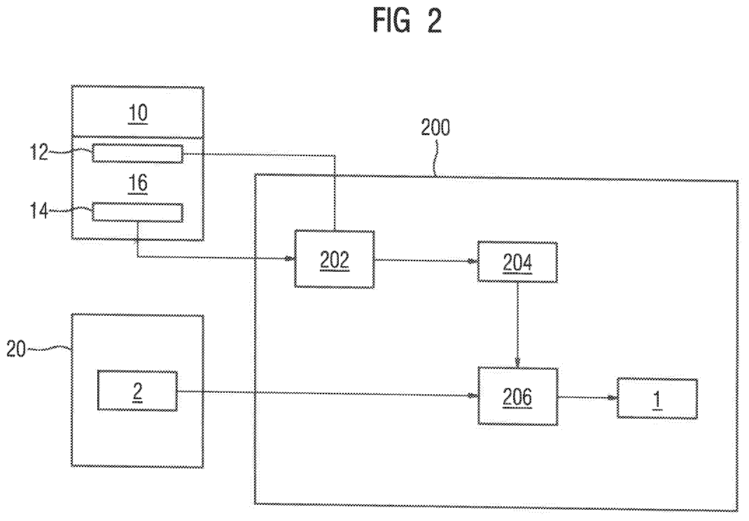

FIG. 2 a block diagram of the decryption of data in accordance with an exemplary embodiment of the method in accordance with the invention.

Corresponding parts are provided with the same reference characters in the figures.

FIGS. 1 and 2 illustrate an exemplary embodiment of the method in accordance with the invention for data transmission from a first data processing unit 100 to a second data processing unit 200. In the method, the data 1 to be transmitted is encrypted by the first data processing unit 100 and the encrypted data 2 is decrypted by the second data processing unit 200. FIG. 1 illustrates a block diagram of the encryption of the data and FIG. 2 illustrates a block diagram of the decryption of the data 1.

In order to encrypt the data 1, a secret key is generated by the first data processing unit 100 using a method 102. The method 102 is invoked by a user input 3 of a user of the first data processing unit 100.

The secret key is stored in a secure storage area 104 of the first data processing unit 100.

In order to secure the secret key on a first external storage medium 10, the secret key is read by the first data processing unit 100 using a method 106 from the secure storage area 104 of the first data processing unit 100 and is encrypted using an additional key 12 that is provided by the first external storage medium 10. The encrypted secret key 14 is stored in a secure storage area 16 of the first external storage medium 10. The method 106 is invoked by a user input 5 of a user of the first data processing unit 100. The additional key 12 is, for example, a salt. The salt can be a specific character string that is stored on the first external storage medium 10, or a random character string that is generated by the first external storage medium 10.

The data 1 is encrypted using a method 108 using the secret key, For this purpose, the secret key is read from the secure storage area 104 of the first data processing unit 100. The method 108 is invoked by a user input 7 of a user of the first data processing unit 100.

The encrypted data 2 is copied to a second external storage medium 20.

In order to transfer the data 1 to the second data processing unit 200, the first external storage medium 10 and the second external storage medium 20 are connected to the second data processing unit 200.

The encrypted secret key 14 and the additional key 12 are read from the first external storage medium 10 by the second data processing unit 200. The encrypted secret key 14 is then decrypted by the second data processing unit 200 using a method 202 and the secret key is stored in a secure storage area 204 of the second data processing unit 200.

Using the secret key, the encrypted data 2 that is read from the second external storage medium 20 is decrypted by the second data processing unit 200 using a method 206 and the decrypted data 1 is stored by the second data processing unit 200.

Each method 102, 106, 108, 202, 206 is a computer program that is executed on the respective data processing unit 100, 200.

The method described with reference to FIGS. 1 and 2 can be modified, for example, in that the encrypted data 2 is copied to the first external storage medium 10 instead of the second external storage medium 20 and is read from the first external storage medium 10 by the second data processing unit 200.

Although the invention has been further illustrated and described in detail by the preferred exemplary embodiments, the invention is not limited in this regard by the disclosed examples and other variations can be derived therefrom by the person skilled in the art without departing the scope of the invention.

Independent of the grammatical term usage, individuals with male, female or other gender identities are included within the term.

1.-9. (canceled)

10. A method for data transmission between two data processing units, the method comprising:
generating a secret key;
encrypting the secret key using an additional key that is provided by a first external storage medium and storing the encrypted secret key in a secure storage area of the first external storage medium;
encrypting data stored on a first data processing unit with the secret key and providing the data encrypted with the secret key to a second data processing unit;
reading with the second data processing unit the encrypted secret key and the additional key from the first external storage medium;
decrypting with the second data processing unit the encrypted secret key with the additional key; and
decrypting with the second data processing unit the data encrypted with the secret key with the secret key.

11. The method of claim 10, further comprising providing the data encrypted with the secret key to the second data processing unit by first copying the encrypted data from the first data processing unit to the first external storage medium or to a second external storage medium and providing the encrypted data to the second data processing unit by the first external storage medium or the second external storage medium.

12. The method of claim 10, wherein the additional key is a salt.

13. The method of claim 12, wherein the salt is a specific character string stored on the first external storage medium.

14. The method of claim 12, wherein the salt is a random character string generated by the first external storage medium.

15. The method of claim 10, further comprising generating by the first data processing unit and stored the secret key in a secure storage area of the first data processing unit.

16. The method of claim 10, further comprising storing the secret key in a secure storage area of the second data processing unit.

17. The method of claim 10, wherein the first external storage medium is a memory card.
